(19) United States
(12) Patent Application Publication
(10) Pub. No.: US 2013/0078076 A1
(43) Pub. Date: Mar. 28, 2013

(54) METHOD FOR TRANSFERRING SUBSTRATE MODULES, AND MAGNETIC SHEET APPLIED IN THE METHOD

(71) Applicants: Hsin Hsiung, Jiangsu Province (CN); Ching-Feng Hsieh, Taipei (TW)

(72) Inventors: Hsin Hsiung, Jiangsu Province (CN); Ching-Feng Hsieh, Taipei (TW)

(73) Assignees: ASKEY COMPUTER CORPORATION, Taipei (TW); ASKEY TECHNOLOGY (JIANGSU) LTD., Jiangsu Province (CN)

(21) Appl. No.: 13/308,498

(22) Filed: Nov. 30, 2011

(30) Foreign Application Priority Data
Sep. 23, 2011 (TW) 100134286

(51) Int. Cl. B65G 47/92; H01F 1/00

(52) U.S. Cl. 414/800; 294/65.5; 335/296

(57) ABSTRACT

A method transfers substrate modules that are formed by cutting a substrate sheet in a cutting machine. The method rapidly and efficiently transfers the substrate modules from the cutting machine to facilitate the transfer of the substrate modules for subsequent processes, thereby reducing operational time and complexity, reducing machine idle time, and increasing operational efficiency, to avoid requiring additional equipment for operation and thus increasing yield as a result.

### BACKGROUND OF THE INVENTION

1. Field of the Invention

The present invention relates to substrate module transfer technologies, and, more particularly, to a method of transferring substrate modules by means of a magnetic sheet.

2. Description of Related Art

The demand for wireless communication products becomes increasingly greater in parallel with the prosperous development of communication industries in recent years, as well as under the pressure of keen competitions among relevant trades.

A wide variety of wireless mobile communication products are available in the market, all of which share a common feature of having a built-in wireless communication module, which includes WiFi, Blue Tooth, and 3G wireless modules, and generally it is divided into embedded or external connection types. The embedded type communication module is typically presented in the form of a Substrate Module which may be constituted by multiple chips, whereas the external connection type is presented in the form of a substrate module integrated with an external system, an outer shell and an electrical connection interface.

Batch production is a common method of manufacturing substrate modules, in which components or substrate units are produced in groups (batches) which are divided to respectively perform circuit printing and punching processes, and finally, a cutting process (i.e. a singulation process) to separate each of the substrate units to form substrate modules.

The foregoing cutting process is performed by positioning a whole piece of substrate sheet containing multiple substrate units within a cutting machine for cutting, which is adapted to cut the substrate sheet into multiple substrate modules, and after finished, each of the detached substrate modules is then to be removed from the cutting machine manually by manpower, before the next substrate sheet can be positioned in place for cutting.

It is therefore evident that not only the task of taking individual substrate modules out of the cutting machine is quite laborious and time consuming, but also it comes with a concern of quality caused by unexpected damage due to incidents of occasional modules colliding with one another. Further, because of the time consuming removal process to take out pieces one by one, the cutting machine would inevitably have an excess idle time and thus results in low efficiency, which may even lead to spending more in purchasing extra equipment in order to satisfy the increasing demand for the expected yield.

Therefore, it is desirable and highly beneficial to discover a more ideal and satisfying manufacturing process, which can overcome the drawbacks as encountered in prior techniques by efficiently and rapidly transferring substrate modules from the cutting machine after the cutting process.

### SUMMARY OF THE INVENTION

In view of the drawbacks associated with the prior techniques, a primary objective of the invention is to provide a method for transferring substrate modules and a magnetic sheet applicable to the method. The present invention has advantages over the prior art by facilitating the transfer of substrate modules, reducing operational time and complexity, reducing machine idle time, increasing operational efficiency and thus avoid requiring additional equipment for operation and thus increasing yield as a result.

To achieve the aforementioned and other objectives, the invention provides method for transferring substrate modules that are formed by cutting a substrate sheet in a cutting machine, each of the substrate modules including magnetically conductive metal, the method comprising: providing a magnetic sheet large enough to cover the whole substrate sheet to cover and attract the substrate modules; and moving the magnetic sheet to a region outside of the cutting machine and detaching the substrate modules from the magnetic sheet.

Further, the invention provides a magnetic sheet applicable for the foregoing method for transferring substrate modules from the cutting machine, the magnetic sheet including a body large enough to completely cover a substrate sheet; and a magnetic substance disposed on a first surface of the body and attracting substrate modules that are formed by cutting the substrate sheet.

In one embodiment, at least one of the substrate modules is a wireless communication module. In another preferred embodiment, the magnetic substance includes a soft magnet or an electromagnetic coil.

In summary, the transfer method of the invention is capable of rapidly and efficiently transferring the processed substrate modules from the cutting machine to facilitate the transfer of the substrate modules for subsequent processes, thereby reducing operational time and complexity, reducing machine idle time, and increasing operational efficiency, to avoid requiring additional equipment for operation and thus increasing yield as a result.

### BRIEF DESCRIPTION OF THE DRAWINGS

The present invention can be more fully understood by reading the following detailed description of the preferred embodiments, with reference made to the accompanying drawings, wherein:

FIG. 1 is a three-dimensional view of a magnetic sheet employed in a transfer method according to the present invention;

FIG. 2A is a schematic view of substrate modules being attracted to a first surface of a magnetic sheet by a magnetic force in accordance with the present invention;

FIG. 2B is a cross-sectional view of a cutting line A-A illustrated in FIG. 2A according to the present invention;

FIGS. 3A and 3B are schematic views showing an preferred embodiment of using a magnetic sheet to efficiently and rapidly transfer substrate modules from the cutting machine in accordance with the present invention; and

FIG. 4 is a flowchart showing a method for transferring substrate modules in accordance with the present invention.

### DETAILED DESCRIPTION OF THE PREFERRED EMBODIMENTS

The following illustrative embodiments are provided to illustrate the disclosure of the present invention, these and other advantages and effects can be understood by persons skilled in the art after reading the disclosure of this specification. Note that the structures, proportions, sizes depicted in the accompanying figures merely illustrate the disclosure of the specification to allow for comprehensive reading without a limitation to the implementation or applications of the present invention, and does not constitute any substantial technical meaning

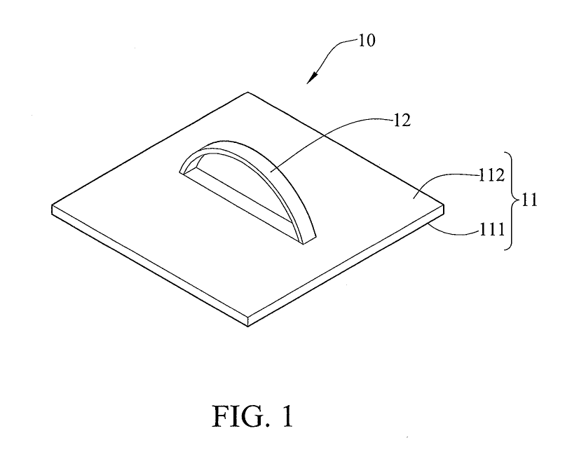

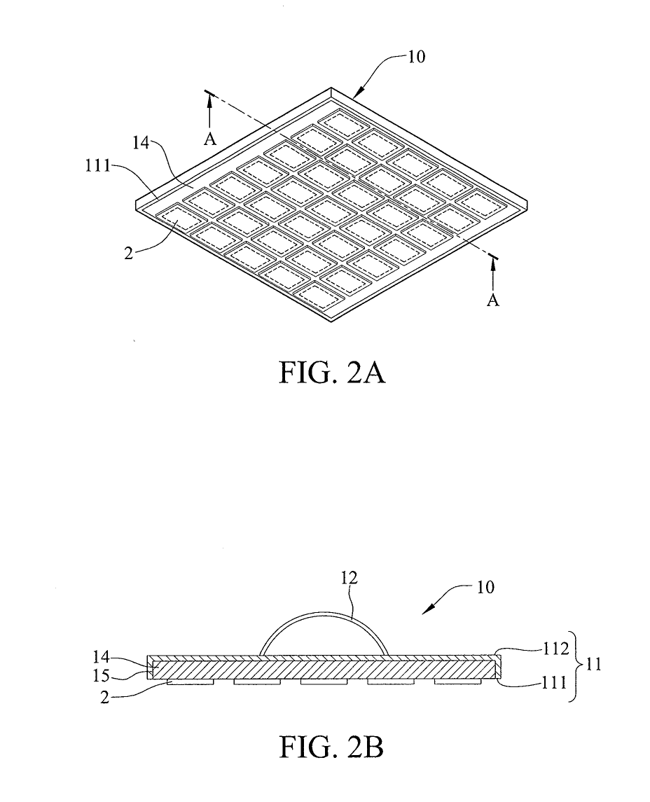

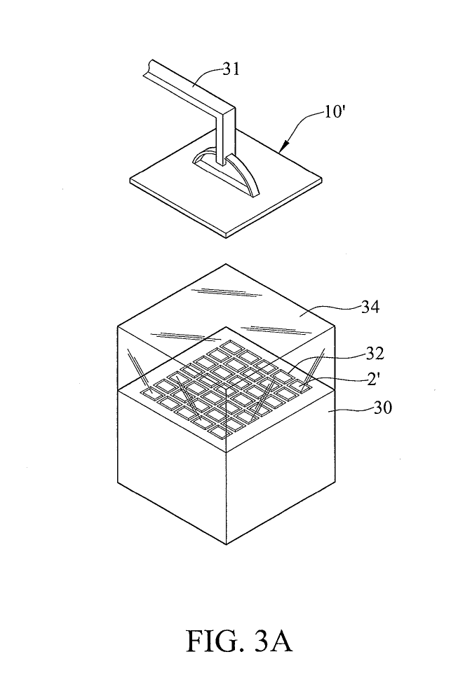

FIG. 1 is a three-dimensional view of the magnetic sheet 10 in accordance with the present invention. FIG. 2A is a schematic view of a plurality of substrate modules 2 being attracted to a first surface of the magnetic sheet 10 as shown in FIG. 1 of the present invention. FIG. 2B is a cross-sectional view showing a cutting line A-A in FIG. 2A according to the present invention.

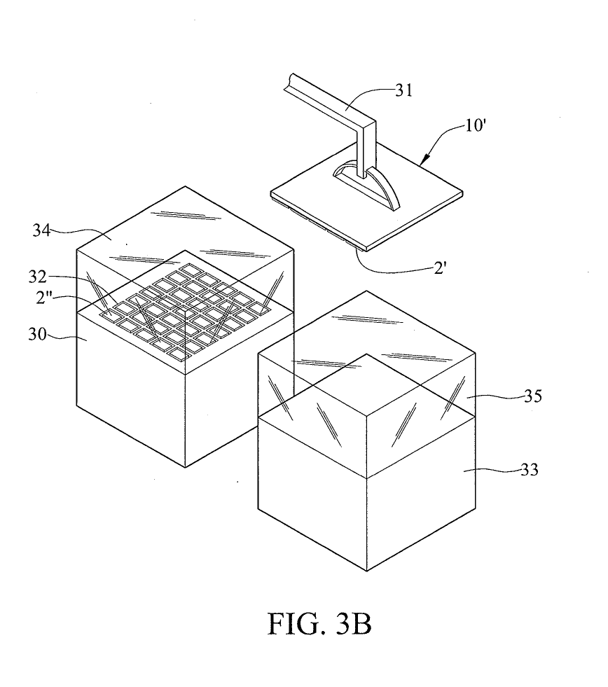

As illustrated in FIGS. 1, 2A and 2B, the magnetic sheet 10 is used for attracting the substrate modules 2 thereto after being cut into separate units by a cutting machine (as shown in FIGS. 3A & 3B). In the embodiment, the substrate modules 2 refer to wireless communication modules each having a magnetically conductive metal formed thereon. In an embodiment, the magnetically conductive metal is a shielding case (used for shielding against electromagnetic waves to prevent the substrate module 2 from being affected by an external electromagnetic filed), or a heat sink disposed on the surface of the substrate modules 2, such that the magnetic sheet 10 can adhere itself directly thereto. The magnetic sheet 10 is employed for the transfer of the substrate modules 2 from the cutting machine after being cut into separate units.

Note that the electromagnetic waves shielding case is made of a metallic material for achieving the effect of electromagnetic interference, EMI, while allowing the magnetic sheet 10 to adhere to multiple substrate modules 2 by magnetic force. Moreover, the substrate modules 2 described in other embodiments of this invention may all include a similar structure to the foregoing shielding case or any other ones that are made of metallic materials and applicable for the transfer method of the present invention.

As shown in FIGS. 1, 2A and 2B, the magnetic sheet 10 according to the present invention comprises a body 11, a magnetic substance 14 (which may be embedded into the body 11), and a hand-held portion 12. The body 11 has a sufficient size to fully cover a whole substrate sheet, and has a first surface 111 and a second surface 112 opposing to the first surface 111 formed on the body 11; and the magnetic substance 14 may be disposed to be embedded into the first surface 111 of the body 11 and may comprise soft magnets or electromagnetic coils for attracting all the separate substrate modules 2 at one time after cutting by magnetic force. The body 11 may further comprise an anti-static adhesive tape 15 that encloses the magnetic substance 14.

The hand-held portion 12 is disposed on the second surface 112 opposing the first surface 111 of the body 11 for being held by a hand. Note that the shape and position of the hand-held portion 12 depicted in the drawing is illustrative rather than restrictive to any variations thereof.

In one embodiment, the substrate modules 2 may be adhered to the magnetic sheet 10 by means of manual or automated controls to remove substrate modules from the cutting machine as required.

FIGS. 3A and 3B describe another embodiment of employing a magnet sheet 10′ of the present invention for rapidly transferring substrate modules 2′ from the machine. As depicted in FIG. 3A, a plurality of substrate modules 2′ have been separately cut by the cutting machine 30 and accommodated in each of the respective grooves 32. The cutting machine 30 comprises isolation mechanism 34 adapted for shielding against dust from the ambient environment in order to increase good yield, such that it is laborious and time consuming to remove each of the separate substrate modules 2′ from their respective grooves.

As such, the present invention provides a transfer mechanism of an automated mechanical arm 31 having a hand-held portion that allows the magnetic sheet 10′ to be held (it may be a manually-operated mechanical arm in other embodiment), by manipulating the magnetic surface of the magnetic sheet 10′ (the bottom surface in this embodiment) toward and adhere substrate modules 2′ to the bottom thereof, as shown in FIG. 3B. For instance, the automated mechanical arm 31 can efficiently transfer the magnetic sheet 10′ along with the substrate modules 2′ adhered thereto to a tool machine platform 33 having isolation mechanisms 35 to proceed with subsequent processing steps.

At the same time, another substrate piece may be placed on the cutting machine to be cut to form a batch of separate substrate modules 2′, thereby increasing the efficiency and yield. Moreover, the adhesion force of the magnetic sheet 10′ can be manipulated (such as by controlling magnetic force of the electromagnetic coil), or by manual operation to detach substrate modules 2′ from the cutting machine 30 to the tool machine platform 33, allowing the tool machine platform 33 to proceed the subsequent process with the substrate modules 2′ after cutting, while allowing the cutting machine 30 to continue cutting the next batch of substrate sheet to be processed, thereby sparing the cutting machine 30 from idling and thus allowing other relevant tool machine platforms to continue processing efficiently. Further, the magnetic sheet 10′ may be installed on the transfer mechanism in the cutting machine 30 to thereby transfer the batch of substrate modules 2′ to the tool machine platform 33 for subsequent processing, thereby effectively reducing transferring time and operational complexity as well as idle time of the cutting machine 30.

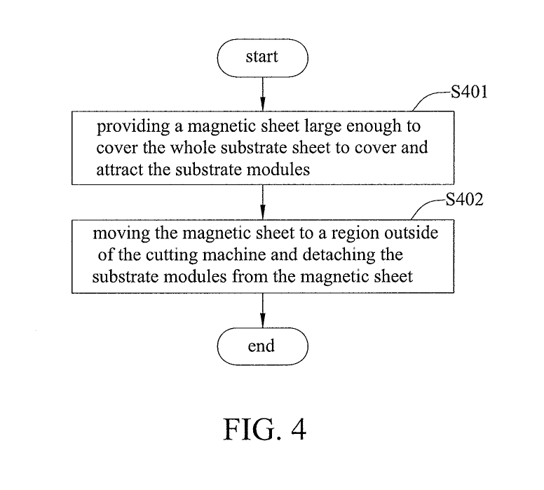

FIG. 4 depicts a first step S401 in which a magnetic sheet having a sufficient size to cover the whole substrate piece and adheres to each of the substrate module having a magnetically conductive metal. In this embodiment, the magnetic sheet may be a magnetic substance having inherent adhesion force, wherein the magnetic substance may be a soft magnet or an electromagnetic coil. In another embodiment, the magnetically conductive is an electromagnetic shielding case or a heat sink disposed on the substrate modules to be cut to thereby facilitate direct adhesion therebetween.

Subsequently, in a next step S402, the magnetic sheet adhered with all the substrate modules after cutting are collectively removed from the cutting machine, and then the substrate modules are detached from the magnetic sheet.

In addition, in an embodiment, the magnetic sheet is installed in the transfer mechanism of the cutting machine to transfer the separate substrate modules after cutting.

Summarizing the above descriptions, the transfer method of this invention is capable of rapidly and efficiently transferring the processed substrate modules from the cutting machine after cutting to facilitate the transfer of substrate modules for subsequent processes, thereby reducing operational time and complexity, reducing machine idle time, increasing operational efficiency to avoid requiring additional equipment for operation and thus increasing yield as a result.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A method for transferring substrate modules that are formed by cutting a substrate sheet in a cutting machine, each of the substrate modules including magnetically conductive metal, the method comprising:
providing a magnetic sheet large enough to cover the whole substrate sheet to cover and attract the substrate modules; and
moving the magnetic sheet to a region outside of the cutting machine and detaching the substrate modules from the magnetic sheet.

2. The method of claim 1, wherein at least one of the substrate modules is a wireless communication module.

3. The method of claim 1, wherein the magnetic sheet has a magnetic substance

4. The method of claim 3, wherein the magnetic substance is a soft magnet or an electromagnetic coil.

5. The method of claim 1, wherein the magnetically conductive metal is a shielding case or a heat sink.

6. The method of claim 1, wherein the magnetic sheet is installed in a transfer mechanism of the cutting machine, and is transferred by the transfer mechanism after the substrate sheet is cut into the substrate modules.

7. A magnetic sheet, comprising:
a body large enough to completely cover a substrate sheet; and
a magnetic substance disposed on a first surface of the body and attracting substrate modules that are formed by cutting the substrate sheet.

8. The magnetic sheet of claim 7, further comprising a hand-held portion disposed on a second surface of the body for a hand to hold the body, the second surface opposing the first surface.

9. The magnetic sheet of claim 7, wherein the magnetic substance includes a soft magnet or an electromagnetic coil.

10. The magnetic sheet of claim 7, further comprising an anti-static adhesive tape that encapsulates the magnetic substance.

11. The magnetic sheet of claim 7, wherein at least one of the substrate modules is a wireless communication module.

12. The magnetic sheet of in claim 7, wherein each of the substrate modules has magnetically conductive metal that is a shielding case or a heat sink installed on a surface of the substrate module.
